(19) United States
(12) Patent Application Publication
(10) Pub. No.: US 2022/0019034 A1
(43) Pub. Date: Jan. 20, 2022

(54) Stabilizing Power Output

(71) Applicant: Waymo LLC, Mountain View, CA (US)

(72) Inventors: Michael Matthews, Portola Valley, CA (US); David Schleuning, Piedmont, CA (US); Carolyn Wozniak, San Francisco, CA (US)

(21) Appl. No.: 16/928,621

(22) Filed: Jul. 14, 2020

(51) Int. Cl. G02B 6/42; G01S 7/481; G01S 7/484; G01S 17/89

(52) U.S. Cl. CPC G02B 6/4203; G02B 6/4249; G01S 17/89; G01S 7/484; G01S 7/4814

(57) ABSTRACT

The present disclosure relates to transmitter modules, vehicles, and methods associated with lidar sensors. An example transmitter module could include a light-emitter die and a plurality of light-emitter devices coupled to the light-emitter die. Each light-emitter of the plurality of light-emitter devices is configured to emit light from a respective emitter surface. The transmitter module also includes a cylindrical lens optically coupled to the plurality of light-emitter devices and arranged along an axis. The light-emitter die is disposed such that the respective emitter surfaces of the plurality of light-emitter devices form a non-zero yaw angle with respect to the axis.

### BACKGROUND

A conventional Light Detection and Ranging (lidar) system may utilize a light-emitting transmitter (e.g., a laser diode) to emit light pulses into an environment. Emitted light pulses that interact with (e.g., reflect from) objects in the environment can be received by a receiver (e.g., a photodetector) of the lidar system. Range information about the objects in the environment can be determined based on a time difference between an initial time when a light pulse is emitted and a subsequent time when the reflected light pulse is received.

### SUMMARY

The present disclosure generally relates to light detection and ranging (lidar) systems, which may be configured to obtain information about an environment. Such lidar devices may be implemented in vehicles, such as autonomous and semi-autonomous automobiles, trucks, motorcycles, and other types of vehicles that can navigate and move within their respective environments.

In a first aspect, a transmitter module is provided. The transmitter module includes a light-emitter die and a plurality of light-emitter devices coupled to the light-emitter die. Each light-emitter of the plurality of light-emitter devices is configured to emit light from a respective emitter surface. The transmitter module also includes a cylindrical lens optically coupled to the plurality of light-emitter devices and arranged along an axis. The light-emitter die is disposed such that the respective emitter surfaces of the plurality of light-emitter devices form a non-zero yaw angle with respect to the axis.

In a second aspect, a method is provided. The method includes providing a light-emitter die that includes a plurality of light-emitter devices. Each light-emitter of the plurality of light-emitter devices is configured to emit light from a respective emitter surface. The method also includes providing a substrate, a cylindrical lens coupled to the substrate and arranged along an axis, a spacer, and a plurality of optical waveguides. The method additionally includes coupling the light-emitter die to the substrate and the spacer such that the respective emitter surfaces of the plurality of light-emitter devices form a non-zero yaw angle with respect to the axis. Each optical waveguide of the plurality of optical waveguides is optically coupled by way of the cylindrical lens to at least one light-emitter device of the plurality of light-emitter devices.

Other aspects, embodiments, and implementations will become apparent to those of ordinary skill in the art by reading the following detailed description, with reference where appropriate to the accompanying drawings.

### BRIEF DESCRIPTION OF THE FIGURES

FIG. 1 illustrates a transmitter module, according to an example embodiment.

FIG. 2A illustrates a portion of the transmitter module of FIG. 1, according to an example embodiment.

FIG. 2B illustrates a portion of the transmitter module of FIG. 1, according to an example embodiment.

FIG. 2C illustrates a portion of the transmitter module of FIG. 1, according to an example embodiment.

FIG. 2D illustrates a portion of the transmitter module of FIG. 1, according to an example embodiment.

FIG. 3A illustrates a configuration of the transmitter module of FIG. 1, according to an example embodiment.

FIG. 3B illustrates a configuration of the transmitter module of FIG. 1, according to an example embodiment.

FIG. 3C illustrates a configuration of the transmitter module of FIG. 1, according to an example embodiment.

FIG. 4A illustrates a graph of power variation versus yaw angle, according to an example embodiment.

FIG. 4B illustrates a graph of normalized etalon power versus yaw angle, according to an example embodiment.

FIG. 4C illustrates a graph of normalized etalon power versus yaw angle, according to an example embodiment.

FIG. 5A illustrates a vehicle, according to an example embodiment.

FIG. 5B illustrates a vehicle, according to an example embodiment.

FIG. 5C illustrates a vehicle, according to an example embodiment.

FIG. 5D illustrates a vehicle, according to an example embodiment.

FIG. 5E illustrates a vehicle, according to an example embodiment.

FIG. 6 illustrates a method, according to an example embodiment.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. Other embodiments can be utilized, and other changes can be made, without departing from the scope of the subject matter presented herein.

Thus, the example embodiments described herein are not meant to be limiting. Aspects of the present disclosure, as generally described herein, and illustrated in the figures, can be arranged, substituted, combined, separated, and designed in a wide variety of different configurations, all of which are contemplated herein.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

### I. Overview

A transmitter (TX) module of a lidar system could include one or more light sources (e.g., laser bars) arranged on a light source substrate. The light sources could be disposed so as to emit light (e.g., light pulses) toward an optical element, such as a fast axis collimation (FAC) lens. Light interacting with the FAC lens could be optically coupled to one or more light guiding elements (e.g., optical waveguides).

In such scenarios, optical back-reflections and other effects can lead to non-deterministic fluctuations in the power and/or spectral wavelength outputted by the TX module. For example, the laser pulse power can vary by over 50%, and laser pulse spectral center could vary by 5 nm (out of 905 nm) or more from pulse to pulse. In some scenarios, fluctuations could be based on environmental factors such as temperature, humidity, physical shock, and/or vibration. In other scenarios, other phenomena could cause variations in the characteristics of optical pulses. Such spurious fluctuations could be difficult to compensate for and/or could lead to incorrect determinations of object range and/or object reflectance. When the lidar system is used in an autonomous vehicle, for example, compensating for such fluctuations and/or determinations of object range and/or reflectance can have broader impact implications on overall cost, complexity, and/or performance.

Example embodiments described herein could improve performance of the TX module by reducing variance in pulse power and more closely control the spectral center of the laser pulses. In some embodiments, methods and systems could include tilting the laser die with respect to a fast axis collimation lens. In such embodiments, tilting the laser die could include rotating it in a yaw direction (e.g., about an axis perpendicular to a major surface of the substrate).

Additionally or alternatively, some embodiments may include coating one or more of the optical elements of the transmitter module with an optical coating. For example, the fast axis collimation lens could be coated with a single- or multi-layer coating with a uniform thickness anti-reflective coating around the cylindrically-shaped optical fiber. In some embodiments, the purpose of the coating is to reduce the amount of reflected light from the surface of the cylindrically-shaped optical fiber.

### II. Example Transmitter Modules

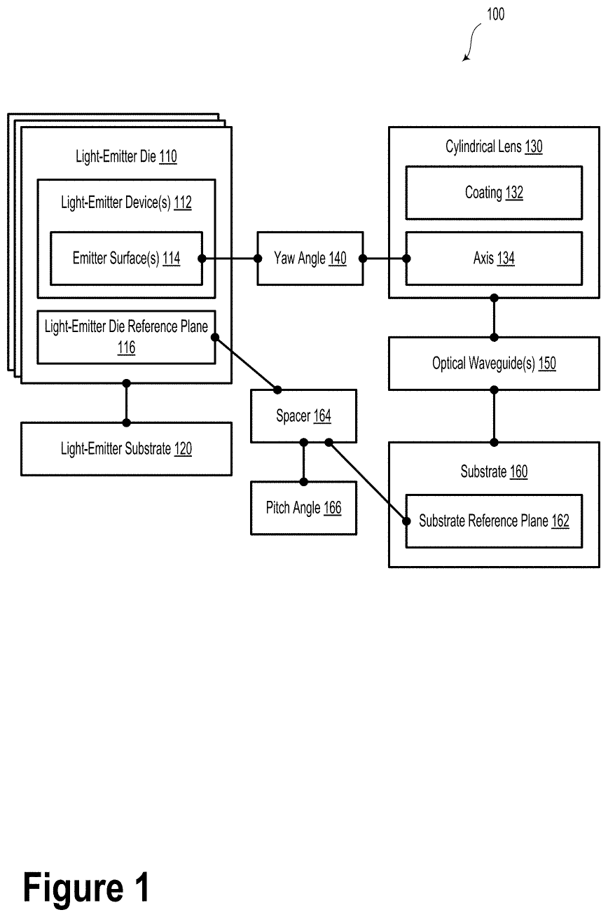

FIG. 1 illustrates a transmitter module 100, according to an example embodiment. In some embodiments, the transmitter module 100 could form an element of a lidar system. However, it will be understood that the transmitter module 100 could be utilized in other contexts as well.

The transmitter module 100 includes a light-emitter die 110.

The transmitter module 100 also includes a plurality of light-emitter devices 112, which could be coupled to the light-emitter die 110. Each light-emitter of the plurality of light-emitter devices 112 is configured to emit light from a respective emitter surface 114.

The transmitter module 100 additionally includes a cylindrical lens 130 optically coupled to the plurality of light-emitter devices 112 and arranged along an axis 134. In such scenarios, the light-emitter die 110 could be disposed such that the respective emitter surfaces of the plurality of light-emitter devices 112 form a non-zero yaw angle 140 with respect to the axis 134.

In various embodiments, the cylindrical lens 130 includes an optical fiber lens configured as a fast axis collimation lens for light emitted from the light-emitter devices 112.

The non-zero yaw angle 140 could be any angle other than zero degrees. For example, the non-zero yaw angle 140 could be between 0.25 degrees and 3 degrees. It will be understood that other non-zero yaw angles are possible and contemplated. It will also be understood that negative angle values are possible and contemplated.

In various embodiments, the transmitter module 100 could additionally include a plurality of optical waveguides 150. Each optical waveguide of the plurality of optical waveguides 150 could be optically coupled to at least one respective light-emitter device of the plurality of light-emitter devices 112 by way of the cylindrical lens 130.

In some embodiments, the transmitter module 100 could additionally include a substrate 160 and a spacer 164. In such scenarios, the spacer 164, the cylindrical lens 130, and the plurality of optical waveguides 150 could be directly coupled to the substrate 160.

In various embodiments, each optical waveguide of the plurality of optical waveguides 150 could be configured to guide light by total internal reflection along a direction substantially parallel to a surface of the substrate 160. In such scenarios, the axis 134 could be parallel to a surface of the substrate 160.

Additionally or alternatively, the spacer 164 could include an optical fiber spacer.

In some embodiments, the transmitter module 100 could further include a light-emitter substrate 120. In such scenarios, the light-emitter die 110 could be coupled to the light-emitter substrate 120.

In example embodiments, the plurality of light-emitter devices 112 could include between 4 and 10 light-emitter devices that are each coupled to the light-emitter die 110.

In various embodiments, a surface of the cylindrical lens 130 could be coated with a coating 132. For example, the coating 132 could be a single- or multi-layer anti-reflective coating.

Each light-emitter device of the plurality of light-emitter devices 112 could include a laser bar configured to emit infrared light. In such scenarios, the infrared light could include light having a wavelength of about 905 nanometers (e.g., between 900 and 910 nanometers). It will be understood that light-emitter devices configured to emit light having other infrared wavelengths (e.g., 700 nanometers to 1 millimeter) are possible and contemplated.

In some embodiments, the transmitter module 100 could additionally include a plurality of further light-emitter die each having a respective plurality of light-emitter devices. In such scenarios, the transmitter module 100 could include a total of 10 to 20 light-emitter die.

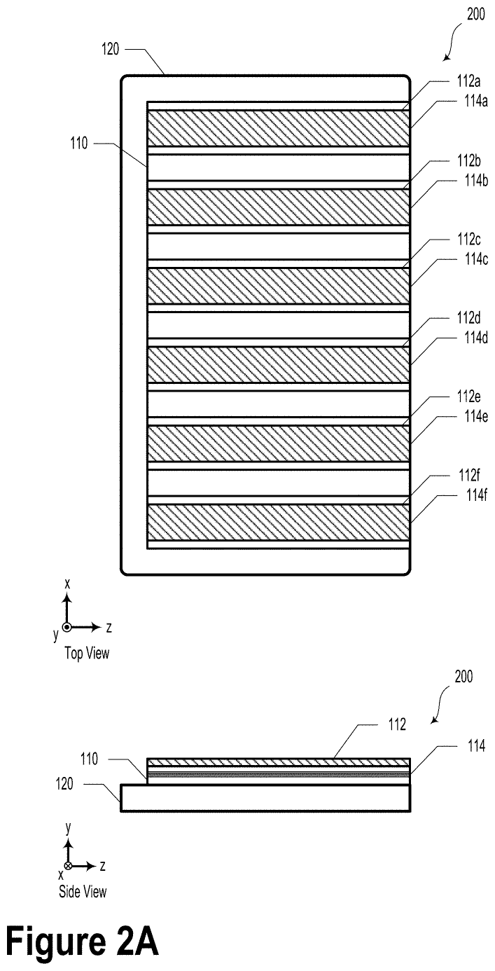

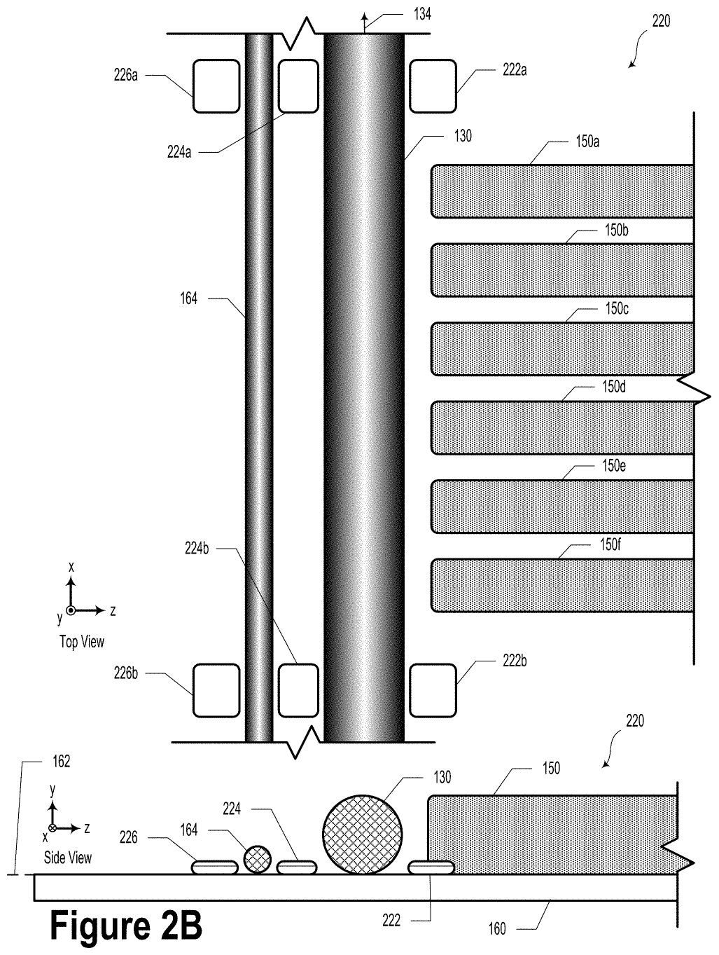

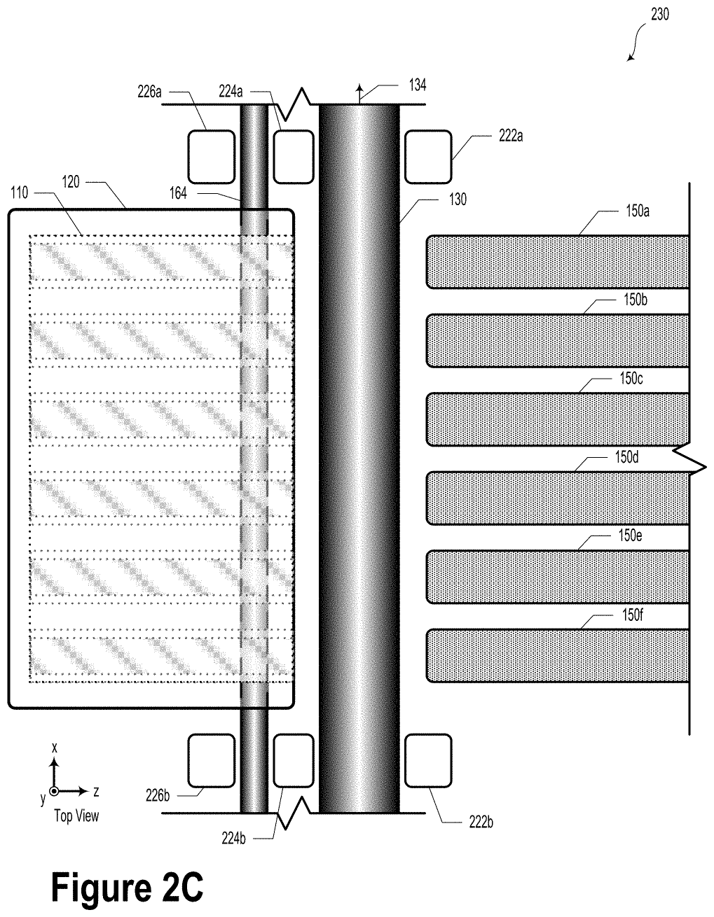

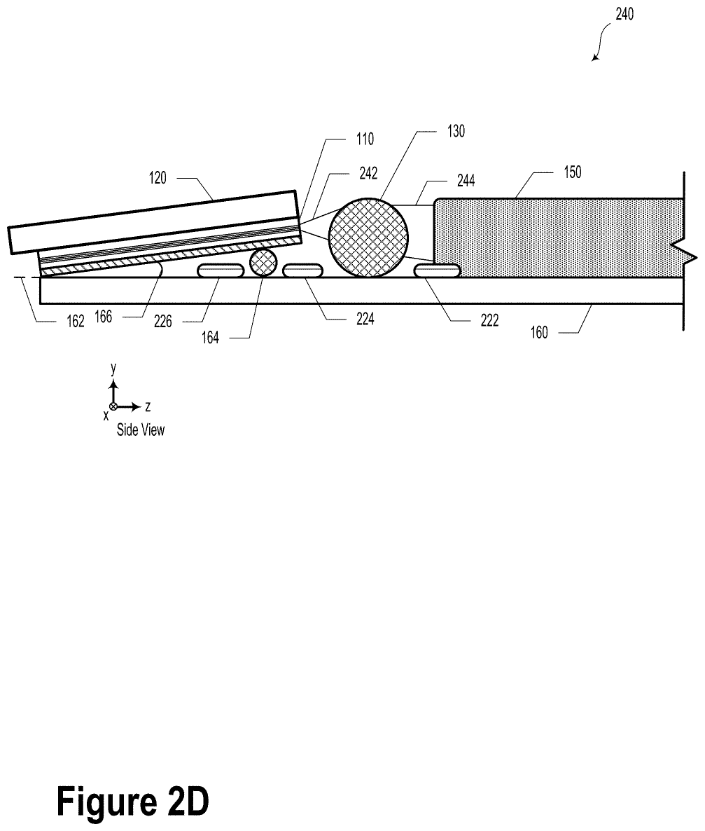

FIGS. 2A-2D illustrate various portions of the transmitter module 100 of FIG. 1, according to one or more example embodiments.

FIG. 2A illustrates several views of a portion 200 of the transmitter module 100 of FIG. 1, according to an example embodiment. Portion 200 includes a light-emitter die 110 arranged along a surface of a light-emitter substrate 120. In some embodiments, the light-emitter die 110 could include a plurality of parallel light-emitter devices (e.g., laser die) 112a-112f, each of which could be configured to emit light from respective emitter surfaces 114a-114f.

It will be understood that FIG. 2A is simplified for clarity and features such as electrical contacts, driver circuits, wire bonds, etc. may be intentionally omitted.

FIG. 2B illustrates several views of a portion 220 of the transmitter module 100 of FIG. 1, according to an example embodiment. Portion 220 includes cylindrical lens 130 and spacer 164, which are disposed along a mounting surface of substrate 160. As illustrated in FIG. 2B, the cylindrical lens 130 and the spacer 164 could be positioned and/or maintained in a desired position by a plurality of reference features 222a, 222b, 224a, 224b, 226a, and 226b. In some examples, the reference features 222a, 222b, 224a, 224b, 226a, and 226b could be formed from photoresist, such as SU-8 or another type of photopatternable material. It will be understood that the elements of FIG. 2B are not necessarily illustrated to scale and the reference features could have a similar height as the optical waveguides 150a-150f with respect to the mounting surface of the substrate 160. While FIG. 2B illustrates the spacer 164 as providing a way to align the light-emitter devices 112a-112f to the cylindrical lens 130 in the vertical direction (e.g., along the y-axis), it will be understood that other ways exist to align various elements of the transmitter module 100.

FIG. 2C illustrates a top view of a portion 230 of the transmitter module 100 of FIG. 1, according to an example embodiment. Portion 230 could include an inverted light-emitter substrate 120 with a light-emitter die 110 that is face-down with respect to the substrate 160. In such a scenario, at least a portion of the light-emitter die 110, such as the light-emitter devices themselves, could be in direct contact with the spacer 164. Furthermore, in some embodiments, at least a portion of the light-emitter substrate 120 could be in direct contact with the substrate 160.

FIG. 2D illustrates a side view of a portion 240 of the transmitter module 100 of FIG. 1, according to an example embodiment. As described above, the light-emitter substrate 120 could be oriented so that light-emitter die 110 is face-down with respect to the substrate 160. Furthermore, at least a portion of the light-emitter die 110 could be in direct contact with the spacer 164. In such scenarios, the light-emitter die 110 could form a pitch angle 166 with respect to a substrate reference plane 162 of the substrate 160. As illustrated in FIG. 2D, the substrate reference plane 162 could be parallel to the x-z plane.

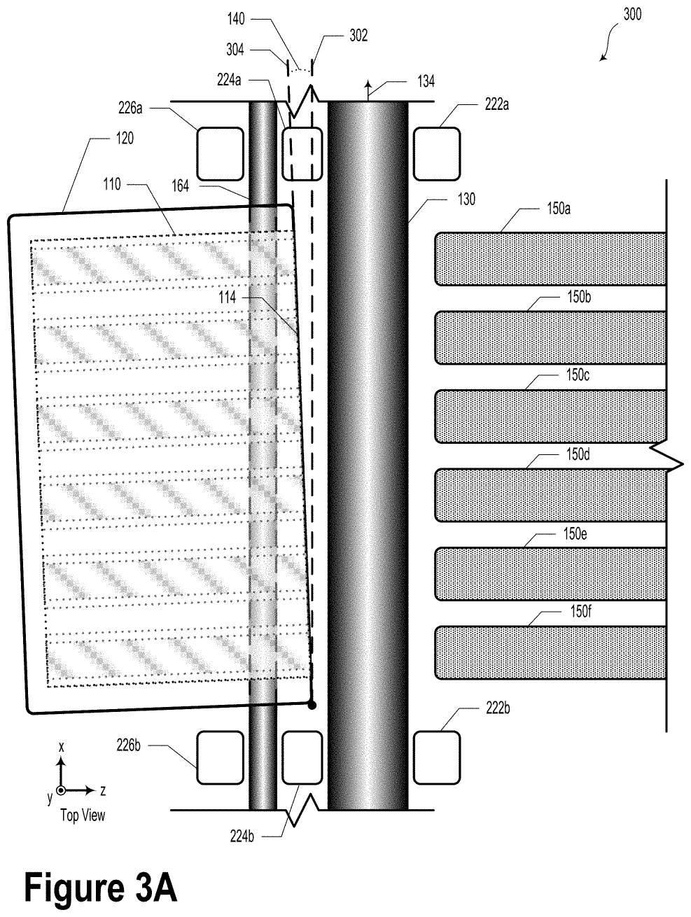

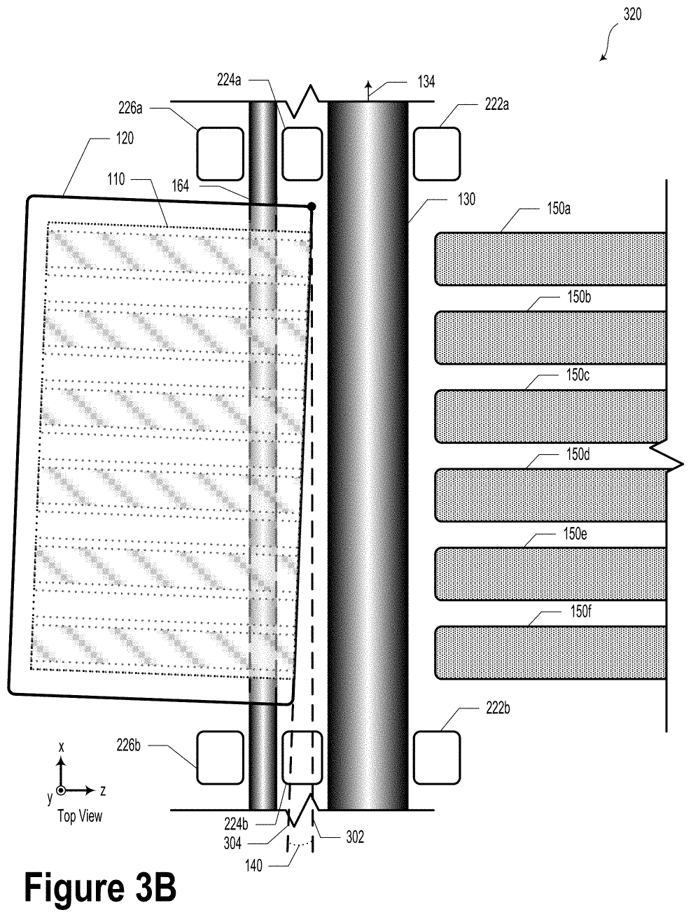

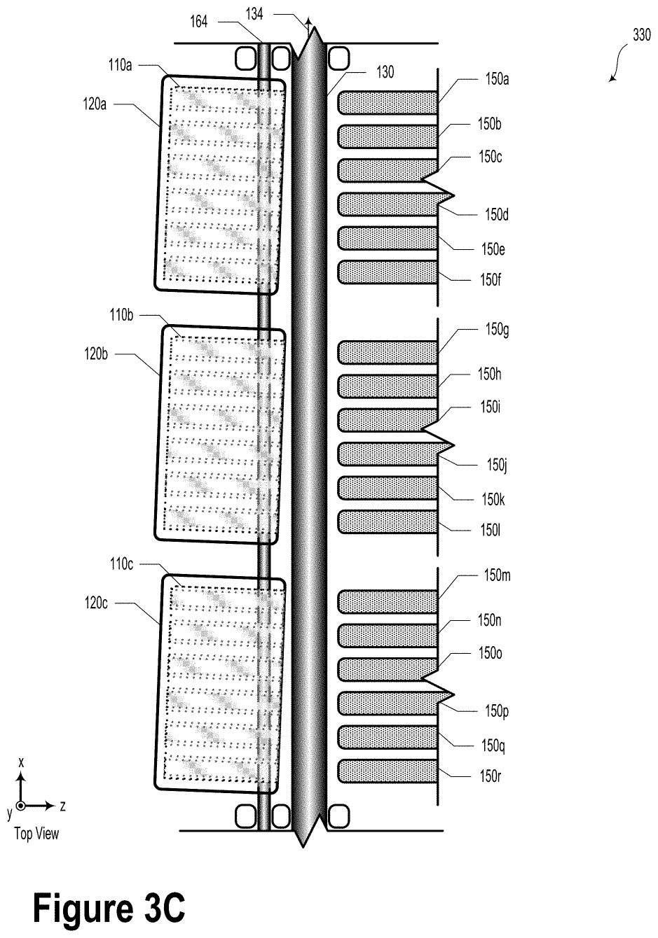

FIG. 3A illustrates a configuration 300 of the transmitter module 100 of FIG. 1, according to an example embodiment. In some embodiments, configuration 300 could include the light-emitter substrate 120 and the light-emitter die 110 as being rotated “counter-clockwise” with respect to one or more other structures of the transmitter module 100, including the spacer 164, the cylindrical lens 130, and/or the optical waveguides 150a-150f For example, the light-emitter substrate 120 and/or light-emitter die 110 could be disposed at a non-zero yaw angle 140 with respect to an axis 134 of the cylindrical lens 130. As illustrated in FIG. 3A, the non-zero yaw angle 140 could be formed between an axis 302 parallel to the axis 134 and an axis 304 that could extend along the emitter surfaces 114.

FIG. 3B illustrates a configuration 320 of the transmitter module 100 of FIG. 1, according to an example embodiment. As illustrated in FIG. 3B, configuration 320 could include the light-emitter substrate 120 as being rotated “clockwise” with respect to other elements of the transmitter module 100, including the spacer 164, the cylindrical lens 130, and/or the optical waveguides 150a-150f. In such a scenario, the light-emitter substrate 120 and/or light-emitter die 110 could be disposed at a yaw angle 140 with respect to an axis 134 of the cylindrical lens 130. As illustrated in FIG. 3A, the non-zero yaw angle 140 could be formed between an axis 302 parallel to the axis 134 and an axis 304 that could extend along the emitter surfaces 114.

As illustrated in FIGS. 3A and 3B, the non-zero yaw angle 140 could be positive or negative and could be between −5 degrees to +5 degrees, −2 degrees to +2 degrees, −1 degree to +1 degree, or another angular range.

FIG. 3C illustrates a configuration 330 of the transmitter module 100 of FIG. 1, according to an example embodiment. Configuration 330 includes a plurality of light-emitter substrates 120a, 120b, and 120c and respective light-emitter die 110a, 110b, and 110c. As illustrated in FIG. 3C, the respective light-emitter devices of each light-emitter die could generally aligned with a respective optical waveguide 150a-150r.

In such a scenario, as illustrated, each light-emitter substrate could be rotated at a similar yaw angle with respect to, for example, the cylindrical lens 130. In some embodiments, it will be understood that the respective light-emitter substrates and, by extension, the corresponding light-emitter die could be disposed at different yaw angles from one another, within the scope of the present disclosure. That is, light-emitter substrate 120a and light-emitter die 110a could be disposed at a +1.0 degree yaw angle while light-emitter substrate 120b and light-emitter die 110b could be disposed at a +0.8 degree yaw angle. Other yaw angle differences, ranges, and/or variations are possible and contemplated.

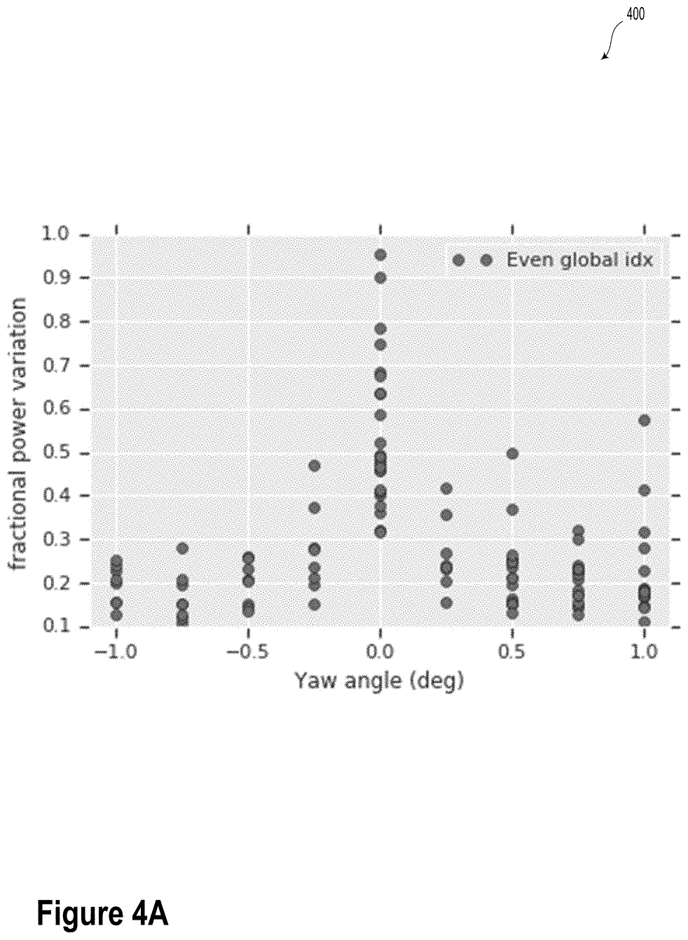

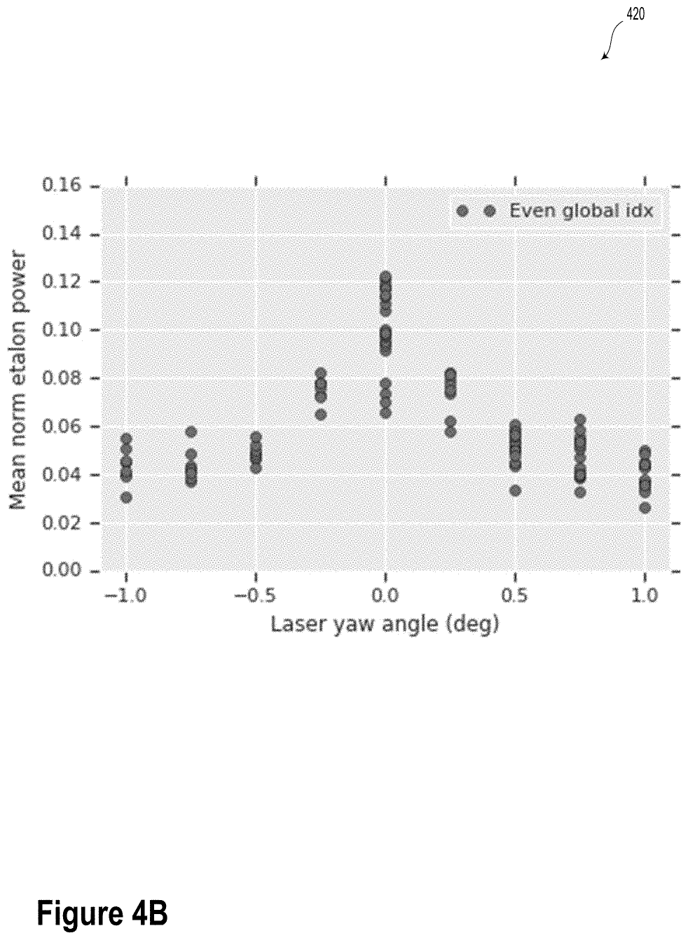

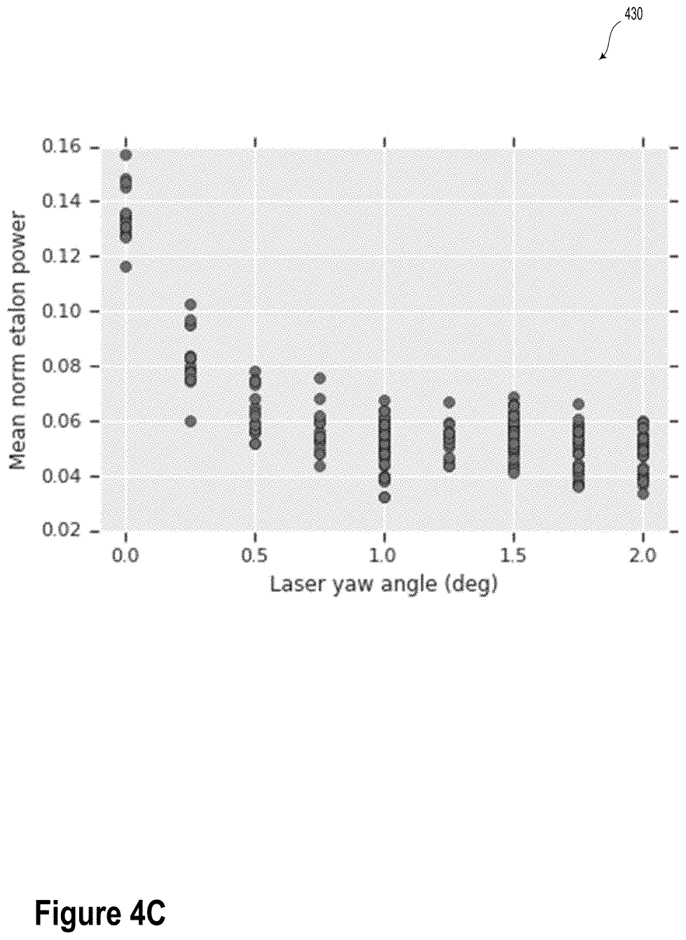

FIG. 4A illustrates a graph 400 of power variation versus yaw angle, according to an example embodiment. Graph 400 illustrates the amount of normalized power received by a photodetector at varying yaw angle from −1.0 degree to +1.0 degree.

FIG. 4B illustrates a graph 420 of normalized etalon power versus yaw angle, according to an example embodiment. Graph 420 illustrates normalized etalon power received by a photodetector while varying yaw angle from −1.0 degree to +1.0 degree. As illustrated in FIG. 4B, non-zero yaw angles can provide lower variance in the amount of transmitted power. By reducing the variance in transmitted power, transmitter module and/or overall lidar system performance could be improved. For example, various aspects of lidar operation could be improved by utilizing the disclosed transmitter module, such as reduced uncertainty in determining range, improved determination of object reflectivity, reduced effect of highly reflective objects, among other examples.

FIG. 4C illustrates a graph 430 of normalized etalon power versus yaw angle, according to an example embodiment. Graph 430 illustrates normalized etalon power received by a photodetector while varying yaw angle from 0 degrees to +2.0 degree.

### III. Example Vehicles

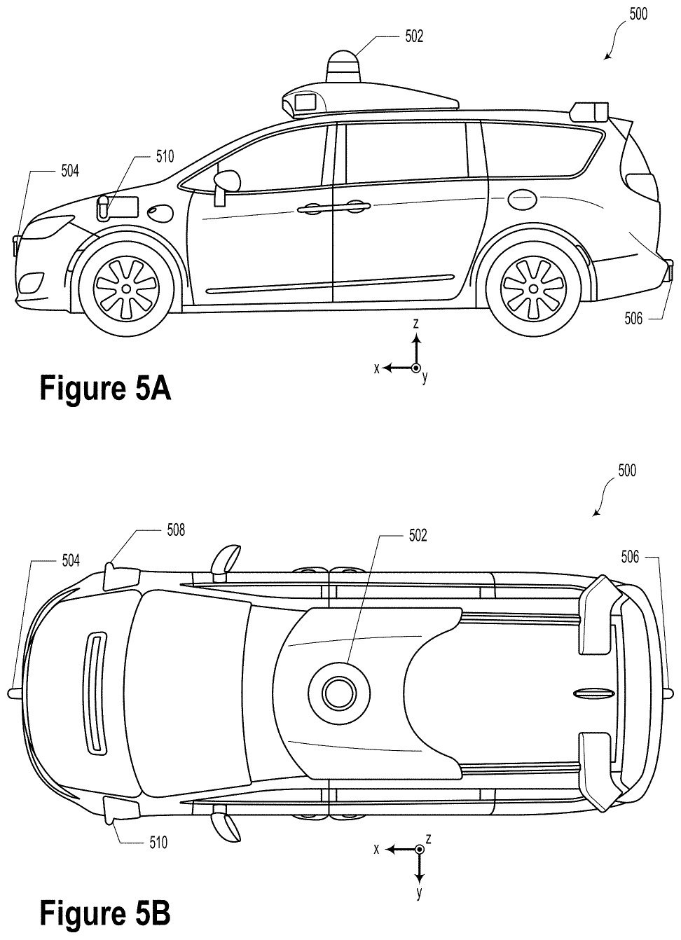

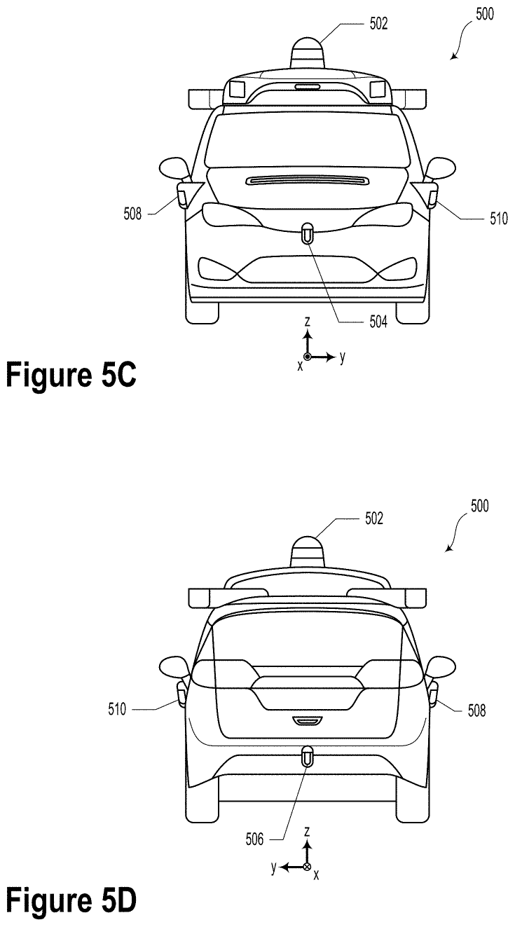

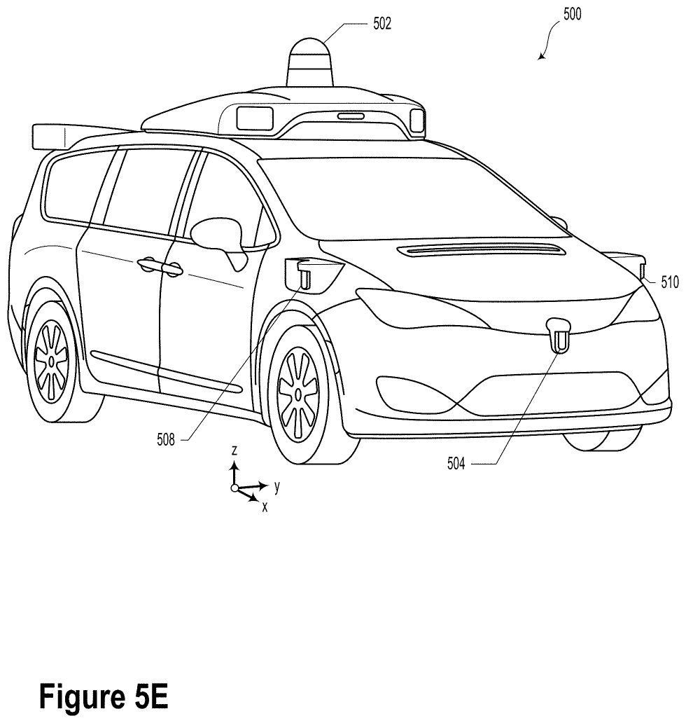

FIGS. 5A, 5B, 5C, 5D, and 5E illustrate a vehicle 500, according to an example embodiment. In some embodiments, the vehicle 500 could be a semi- or fully-autonomous vehicle. While FIGS. 5A, 5B, 5C, 5D, and 5E illustrates vehicle 500 as being an automobile (e.g., a passenger van), it will be understood that vehicle 500 could include another type of autonomous vehicle, robot, or drone that can navigate within its environment using sensors and other information about its environment.

The vehicle 500 may include one or more sensor systems 502, 504, 506, 508, and 510. In some embodiments, sensor systems 502, 504, 506, 508, and 510 could include transmitter module(s) 100 as illustrated and described in relation to FIG. 1. In other words, the transmitter modules and lidar systems described elsewhere herein could be coupled to the vehicle 500 and/or could be utilized in conjunction with various operations of the vehicle 500. As an example, the transmitter module 100 and/or lidar systems described herein could be utilized in self-driving or other types of navigation, planning, perception, and/or mapping operations of the vehicle 500.

While the one or more sensor systems 502, 504, 506, 508, and 510 are illustrated on certain locations on vehicle 500, it will be understood that more or fewer sensor systems could be utilized with vehicle 500. Furthermore, the locations of such sensor systems could be adjusted, modified, or otherwise changed as compared to the locations of the sensor systems illustrated in FIGS. 5A, 5B, 5C, 5D, and 5E.

In some embodiments, sensor systems 502, 504, 506, 508, and 510 could include a plurality of light-emitter devices arranged over a range of angles with respect to a given plane (e.g., the x-y plane) and/or arranged so as to emit light toward different directions within an environment of the vehicle 500. For example, one or more of the sensor systems 502, 504, 506, 508, and 510 may be configured to rotate about an axis (e.g., the z-axis) perpendicular to the given plane so as to illuminate an environment around the vehicle 500 with light pulses. Based on detecting various aspects of reflected light pulses (e.g., the elapsed time of flight, polarization, intensity, etc.), information about the environment may be determined.

In an example embodiment, sensor systems 502, 504, 506, 508, and 510 may be configured to provide respective point cloud information that may relate to physical objects within the environment of the vehicle 500. While vehicle 500 and sensor systems 502, 504, 506, 508, and 510 are illustrated as including certain features, it will be understood that other types of sensor systems are contemplated within the scope of the present disclosure.

Lidar systems with single or multiple light-emitter devices are also contemplated. For example, light pulses emitted by one or more laser diodes may be controllably directed about an environment of the system. The angle of emission of the light pulses may be adjusted by a scanning device such as, for instance, a mechanical scanning mirror and/or a rotational motor. For example, the scanning devices could rotate in a reciprocating motion about a given axis and/or rotate about a vertical axis. In another embodiment, the light-emitter device may emit light pulses towards a spinning prism mirror, which may cause the light pulses to be emitted into the environment based on an angle of the prism mirror angle when interacting with each light pulse. Additionally or alternatively, scanning optics and/or other types of electro-opto-mechanical devices are possible to scan the light pulses about the environment. While FIGS. 5A-5E illustrate various lidar sensors attached to the vehicle 500, it will be understood that the vehicle 500 could incorporate other types of sensors.

### IV. Example Methods

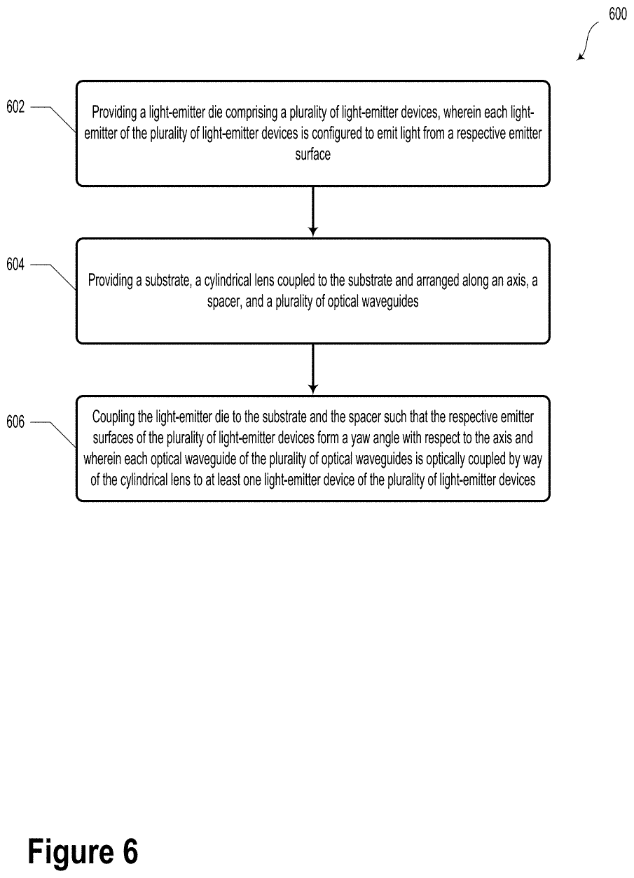

FIG. 6 illustrates a method 600, according to an example embodiment. It will be understood that the method 600 may include fewer or more steps or blocks than those expressly illustrated or otherwise disclosed herein. Furthermore, respective steps or blocks of method 600 may be performed in any order and each step or block may be performed one or more times. In some embodiments, some or all of the blocks or steps of method 600 may relate to elements of transmitter module 100 and/or vehicle 500 as illustrated and described in relation to FIGS. 1 and 5A-5E, respectively. For example, method 600 could describe a method of manufacturing at least a portion of transmitter module 100 and/or a portion of a lidar device.

Block 602 includes providing a light-emitter die (e.g., light-emitter die 110). In some embodiments, the light-emitter die could include a plurality of light-emitter devices (e.g., light-emitter devices 112). In various embodiments, each light-emitter of the plurality of light-emitter devices could be configured to emit light from a respective emitter surface (e.g., emitter surface(s) 114).

Block 604 includes providing a substrate (e.g., substrate 160). Additionally, a cylindrical lens (e.g., cylindrical lens 130) could be provided. The cylindrical lens may be coupled to the substrate and could be arranged along an axis (e.g., axis 134). Block 604 could additionally or alternatively include providing a spacer (e.g., spacer 164) and a plurality of optical waveguides (e.g., optical waveguides 150).

Block 606 could include coupling the light-emitter die to the substrate and the spacer such that the respective emitter surfaces of the plurality of light-emitter devices form a non-zero yaw angle (e.g., non-zero yaw angle 140) with respect to the axis. In some embodiments, each optical waveguide of the plurality of optical waveguides could be optically coupled by way of the cylindrical lens to at least one light-emitter device of the plurality of light-emitter devices.

In various embodiments, coupling the light-emitter die to the substrate and the spacer could include, for example, using a pick-and-place tool to position the light-emitter die with respect to the substrate based on one or more reference features. As an example, the reference features could be formed in photoresist on the substrate, the light-emitter die, or another surface. Additionally or alternatively, the reference features could be formed by etched structures present on one or more of the substrate, the light-emitter die, or another surface.

In some embodiments, the light-emitter die could be coupled to a light-emitter substrate (e.g., light-emitter substrate 120). In such scenarios, coupling the light-emitter die to the substrate and the spacer could include applying a cureable adhesive material (e.g., a thermoset epoxy) to at least one of the substrate or the light-emitter substrate. In such scenarios, method 600 could include curing the adhesive material so as to fix the respective emitter surfaces of the plurality of light-emitter devices at the yaw angle with respect to the axis.

Additionally or alternatively, coupling the light-emitter die to the substrate and the spacer could include positioning the light-emitter die using a computer vision technique.

In some embodiments, method 600 could include coating the cylindrical lens with a single- or multi-layer anti-reflective coating (e.g., coating 132). In some embodiments, the coating 132 could be applied by way of e-beam deposition or other thin-film deposition techniques.

In some embodiments, systems and methods could include reducing power fluctuations in an optical system (e.g., a lidar system). For example, methods could include positioning, or adjusting a position of, a light-emitter die at an angle (e.g., a yaw direction) relative to a fast axis collimation lens. In such scenarios, positioning the light-emitter die could be performed once, periodically, and/or dynamically.

The particular arrangements shown in the Figures should not be viewed as limiting. It should be understood that other embodiments may include more or less of each element shown in a given Figure. Further, some of the illustrated elements may be combined or omitted. Yet further, an illustrative embodiment may include elements that are not illustrated in the Figures.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods of time. Thus, the computer readable media may include secondary or persistent long term storage, like read only memory (ROM), optical or magnetic disks, compact-disc read only memory (CD-ROM), for example. The computer readable media can also be any other volatile or non-volatile storage systems. A computer readable medium can be considered a computer readable storage medium, for example, or a tangible storage device.

While various examples and embodiments have been disclosed, other examples and embodiments will be apparent to those skilled in the art. The various disclosed examples and embodiments are for purposes of illustration and are not intended to be limiting, with the true scope being indicated by the following claims.

What is claimed is:

1. A transmitter module comprising:
a light-emitter die;
a plurality of light-emitter devices coupled to the light-emitter die, wherein each light-emitter of the plurality of light-emitter devices is configured to emit light from a respective emitter surface; and
a cylindrical lens optically coupled to the plurality of light-emitter devices and arranged along an axis, wherein the light-emitter die is disposed such that the respective emitter surfaces of the plurality of light-emitter devices form a non-zero yaw angle with respect to the axis.

2. The transmitter module of claim 1, wherein the non-zero yaw angle is between 0.25 degrees and 3 degrees.

3. The transmitter module of claim 1, further comprising a plurality of optical waveguides, wherein each optical waveguide of the plurality of optical waveguides is optically coupled to at least one respective light-emitter device of the plurality of light-emitter devices by way of the cylindrical lens.

4. The transmitter module of claim 3, further comprising a substrate and a spacer, wherein the spacer, the cylindrical lens, and the plurality of optical waveguides are directly coupled to the substrate.

5. The transmitter module of claim 4, wherein each optical waveguide of the plurality of optical waveguides is configured to guide light by total internal reflection along a direction substantially parallel to a surface of the substrate.

6. The transmitter module of claim 4, wherein the axis is parallel to a surface of the substrate.

7. The transmitter module of claim 4, wherein the spacer comprises an optical fiber.

8. The transmitter module of claim 1, further comprising a light-emitter substrate, wherein the light-emitter die is coupled to the light-emitter substrate.

9. The transmitter module of claim 1, wherein the plurality of light-emitter devices comprises between 4 and 10 light-emitter devices that are each coupled to the light-emitter die.

10. The transmitter module of claim 1, wherein the cylindrical lens comprises an optical fiber configured as a fast axis collimation lens for light emitted from the light-emitter devices.

11. The transmitter module of claim 10, wherein a surface of the cylindrical lens is coated with an anti-reflective coating.

12. The transmitter module of claim 1, wherein each light-emitter device of the plurality of light-emitter devices comprises a laser bar configured to emit infrared light.

13. The transmitter module of claim 12, wherein the infrared light comprises light having a wavelength about 905 nanometers.

14. The transmitter module of claim 1, further comprising a plurality of further light-emitter dies each having a plurality of light-emitter devices.

15. A method comprising:
providing a light-emitter die comprising a plurality of light-emitter devices, wherein each light-emitter of the plurality of light-emitter devices is configured to emit light from a respective emitter surface;
providing a substrate, a cylindrical lens coupled to the substrate and arranged along an axis, a spacer, and a plurality of optical waveguides; and
coupling the light-emitter die to the substrate and the spacer such that the respective emitter surfaces of the plurality of light-emitter devices form a non-zero yaw angle with respect to the axis and wherein each optical waveguide of the plurality of optical waveguides is optically coupled by way of the cylindrical lens to at least one light-emitter device of the plurality of light-emitter devices.

16. The method of claim 15, wherein coupling the light-emitter die to the substrate and the spacer comprises using a pick-and-place tool to position the light-emitter die with respect to the substrate based on one or more reference features.

17. The method of claim 15, further comprising coating the cylindrical lens with an anti-reflective coating.

18. The method of claim 17, wherein coating the cylindrical lens comprises coating the cylindrical lens with an anti-reflective coating.

19. The method of claim 15, wherein the light-emitter die is coupled to a light-emitter substrate, wherein coupling the light-emitter die to the substrate and the spacer comprises applying a cureable adhesive material to at least one of the substrate or the light-emitter substrate and curing the adhesive material so as to fix the respective emitter surfaces of the plurality of light-emitter devices at the non-zero yaw angle with respect to the axis.

20. The method of claim 15, wherein coupling the light-emitter die to the substrate and the spacer comprises positioning the light-emitter die using a computer vision technique.
